(19) United States
(12) Patent Application Publication
(10) Pub. No.: US 2006/0036504 A1
(43) Pub. Date: Feb. 16, 2006

(54) Dynamically classifying items for international delivery

(76) Inventors: William W. Allocca, Bellevue, WA (US); Girish S. Lakshman, Issaquah, WA (US); Leilehua Maly, Bellevue, WA (US); Michael T. McKenna, Bellevue, WA (US); Sangeetha Ranganath, Bellevue, WA (US); Jay T. Skeer, Seattle, WA (US); Kristin E. Toth, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/916,772

(22) Filed: Aug. 11, 2004

(51) Int. Cl. G06Q 30/00

(52) U.S. Cl. 705/26

(57) ABSTRACT

A method, system, and computer-readable medium for assisting in automatically classifying items with respect to one or more predefined classification systems is described, such as for items to be delivered internationally. In some situations, the items are classified so as to select an appropriate import tax code for a destination country and/or to select an appropriate export tax code for an origination country, such as to allow calculation of estimated taxes for the items before the items are delivered. Moreover, in some such situations the automatic classifying is performed dynamically at the time an item order is being placed or considered by a customer. The estimated costs for the items can further in some situations be used to estimate total costs for delivering an item internationally, such as dynamically during the ordering process for the items so that those costs can be collected before delivering the items.

### TECHNICAL FIELD

The following disclosure relates generally to ordering and delivering items, and more particularly to techniques for automatically classifying items to be delivered internationally, such as dynamically at the time the items are ordered and in an automatic manner based on attributes of the items.

### BACKGROUND

The Internet comprises a vast number of computers and computer networks that are interconnected through communication links, with information being exchanged using various services such as electronic mail, FTP, Gopher, and the World Wide Web (also referred to as the “Web”). In addition to merely providing access to information, the Web has increasingly become a medium that is used to search for, shop for and order items (such as products and/or services) that are for purchase, rent, lease, license, trade, evaluation, sampling, etc. In many circumstances, a user can visit the Web site of a Web merchant (or a “Web store”) or other electronic marketplace that sells one or more items. Once there, the user can view information about the items, give an instruction to place an order for one or more items, and provide information needed to complete the purchase (e.g., payment and shipping information).

After receiving an order for one or more items, a Web merchant then fulfills the order by first determining how and when to provide the ordered items to the indicated recipient and then providing the items in the determined manner. Some product items may be available to be delivered electronically to a recipient (e.g., providing email service), while others may be provided physically (e.g., performing cleaning services at the purchaser's house). The order fulfillment process typically used by Web merchants for product items that are to be physically provided shares similarities with other item ordering services that ship ordered items (e.g., catalog-based shopping, such as from mail-order companies).

Before purchasing an item, it is typical for a user to view information about a product on an “item detail page.” The information provided on an item detail page may include such information as the item's name and source, a picture of the item, a description of the item, reviews or ratings of the item, a price at which the item is offered for sale, and one or more controls (e.g., a button) that may be activated by the user to order the item from the Web merchant.

Although such electronic shopping can provide many benefits, difficulties can still arise, such as in situations involving international delivery of an order with the recipient in a different country than the Web merchant or other supplier of one or more items in the order. For example, many countries charge one or more of various types of import taxes (e.g., custom duty tariffs, port handling fees, etc.) on at least some items imported into the country, and some countries may similarly charge one or more of various types of export taxes on at least some items exported from the country. Unfortunately, determining the amount of any such import and/or export taxes and providing for payment of such taxes presents various difficulties, as discussed in greater detail below.

In particular, each country may have hundreds or thousands of distinct classifications of types of items that can be imported, with each classification corresponding to a different tax rate or tax amount. Each such import classification is typically assigned a distinct import tax code (e.g., a harmonized tax code based on the Harmonized Commodity Description and Coding System of the Customs Cooperation Council and World Customs Organization, such as the Harmonized Tariff System of the United States; a code based on the SITC system of the United Nations; a code based on the North American Industry Classification System; etc.), and many countries also maintain a separate set of export tax or other classification codes (e.g., the Schedule B commodity codes of the United States, the Export Control Classification Numbers of the United States and Export Control Numbers of other countries, etc.) for classifying types of items that can be exported. Moreover, a country's import and export codes for an item may be different.

Moreover, many countries' tax codes are organized hierarchically such that a top-level code may correspond to a general type or category of items, and such that children codes of a parent code in the hierarchy each correspond to a subset of the parent code's corresponding items. For example, some paper-based items such as printed books, newspapers and pictures may generally be classified under the Harmonized Tariff System as belonging to chapter “49”, with a subset of those items that includes printed books, brochures and leaflets being classified under heading “01” of chapter 49 (i.e., “4901”), and with a further subset of heading “01” including items having single sheets being classified under sub-heading “10” (i.e., “4901.10”), and with a further subset of single sheet items that are reproduction proofs being classified at the statistical suffix level of “4901.10.0020” and with other single sheet items being classified at the statistical suffix level of “4901.10.0040”. Additional details related to the Harmonized Tariff System are available at ftp://ftp.usitc.gov/pub/reports/studies/0400htsa.pdf, which is hereby incorporated by reference in its entirety.

Due to the high level of detail involved in such tax code systems, as well as the similarity or overlap of many distinct classifications (often corresponding to tax codes in significantly different branches of a tax code hierarchy), it can be extremely difficult to manually classify even a small number of items for a single destination country. These difficulties are greatly exacerbated when a large number of items need to be classified and/or there are a large number of potential destination countries into which the items may be delivered. Moreover, manual assignment of an appropriate tax code for each destination country to each item cannot address a variety of common situations, such as when the group of items to be classified can change (e.g., by having new items being added), when individual items can change (e.g., having attributes of an item change sufficiently to change the tax code for the item), and when classification rules or procedures change.

Thus, until officials for origination and/or destination countries make an actual manual classification determination during the delivery process for items, the complexity of the item classification process often prevents the accurate identification of appropriate tax codes for those items. As a result, the total cost of having those items delivered often cannot be determined at the time that an order is being placed, preventing a merchant from obtaining that total cost from a customer prior to item delivery. Such difficulties cause many merchants to decline to offer items for international delivery, or at best to offer only a very limited number of items for delivery to a very limited number of destination countries. Alternatively, some merchants may attempt to perform international delivery without knowing the cost of import and/or export taxes at the time an order is placed and shipped, such as by attempting to assign responsibility for such costs to the customer (e.g., by shipping items Delivered Duty Unpaid, Ex Works, Free On Board, etc.). However, such policies deter many customers from ordering the items, at least in part due to the unknown costs of import and/or export taxes, and a merchant may still be liable for various costs if a customer declines to accept the items after they have been shipped.

Thus, in view of these disadvantages of conventional techniques for delivering items internationally, it would be beneficial to provide functionality to allow automatic and dynamic classifications of items to appropriate tax codes of item origination and/or destination countries, as well as other techniques discussed in greater detail below.

### BRIEF DESCRIPTION OF THE DRAWINGS

FIGS. 1A-1E illustrate examples of information used for automatically and dynamically classifying items for target countries.

FIG. 2 is a block diagram illustrating an embodiment of a system for automatically and dynamically classifying items for target countries.

FIG. 3 is a flow diagram of an embodiment of a Dynamic Item Classifier routine.

FIG. 4 is a flow diagram of an embodiment of an Attribute Set Identifier subroutine.

FIG. 5 is a flow diagram of an embodiment of an Attribute Set Matcher subroutine.

### DETAILED DESCRIPTION

A software facility is described below that assists in automatically classifying items with respect to one or more predefined classification systems, such as classification systems of countries when items are being delivered internationally to or from those countries. In some embodiments, the items are classified so as to select an appropriate import tax code for a destination country and/or to select an appropriate export tax code for an origination country, such as to allow calculation of delivery-related tax costs for the items before the items are delivered. Moreover, in some such embodiments the automatic classifying is performed dynamically at the time an item order is being placed or considered by a customer.

Various information about items can be used in various embodiments to assist in automatically classifying the items. For example, in some embodiments each of the items has an associated description that includes various attributes for the item. A particular book item, for example, may have various attributes indicating physical aspects of the item (e.g., weight, binding type, number of pages, etc.) and aspects related to the book's contents (e.g., genre, language, etc.), while a particular toy item may have other types of attributes (e.g., to indicate whether the item is educational, is battery powered, and is appropriate for particular ages, as well as to indicate the toy's weight). The attributes for an item can be defined in various ways, such as by each including an attribute type (e.g., “weight” or “genre”) and a corresponding value for the item for that attribute type (e.g., weight=2 lbs and genre=“fiction”). In addition, in some embodiments each item will be associated with one or more item categories (e.g., “book” or “toy”), with each item category having various associated attribute types that can be specified for items of that category (e.g., book items having attributes that include weight, genre and binding type, and toy items having attributes that include weight, educational, and appropriate ages). Such item attributes and categories may be specified in various ways (e.g., by the item manufacturer, supplier and/or merchant), and may be used for various purposes, such as to allow customers to search for or browse for items with specific attributes.

In addition to their other uses, the specified attributes of items are further used in some embodiments to assist in the automatic classification of the items. In particular, in some embodiments predefined mappings are obtained that associate sets of attributes to corresponding country tax codes, and one of the predefined mappings that matches the attributes of an item can then be selected as part of the classification process. For example, books with “hardback” binding types that are of the “fiction” genre and in the “Spanish” language may be associated with a first tax code of a particular country, and books with “paperback” binding types and more than 200 pages may be associated with a second distinct tax code of that country. Using this example, a particular hardback fiction book in Spanish can then be automatically classified as corresponding to the first tax code of that country.

More generally, in some embodiments one or more of a variety of types of predefined classification systems may be used that include not only various import and/or export tax code classification systems, but also classification systems not related to taxes, such as for import and/or export compliance (e.g., Export Control Numbers for use in restricting exports, Schedule B commodity codes for tracking exports, etc.). Thus, the predefined mappings in those embodiments associate sets of attributes to corresponding codes or other classification indications for the classification systems in use. Since each classification system may have hundreds or thousands of distinct codes, and since in some embodiments each classification code in each classification system of interest has one or more predefined mappings that each associate a unique set of item attributes with that classification code, thousands of predefined mappings may be created and used for each classification system. Moreover, since at least some classification systems differ for different countries, each country may have their own distinct set of predefined mappings for use with a classification system. As discussed in greater detail below, the predefined mappings of attribute sets to classification system codes can be obtained in various ways, including by automatically learning appropriate sets of attributes for tax codes based on items that have previously been actually classified to tax codes of a country by an appropriate government official of that country.

Thus, after the predefined mappings of attribute sets to tax codes of countries or other classification codes are available, the attributes of an item can be automatically matched to one of the sets of attributes in the predefined mappings, and the corresponding classification code for that matching predefined mapping can then be selected for use in classifying the items for that country.

The matching of an item to an appropriate attribute set of a predefined mapping may be performed in various ways in various embodiments. For example, multiple attribute sets may each match the attributes of the item, and if so, the attribute set with the largest number of matching attributes may be selected in some embodiments. In other embodiments, additional matching techniques could be used, such as by having a hierarchy of attribute sets, and by traversing the hierarchy to locate successively more detailed attribute sets that match the item attributes until a lowest level attribute set that matches the item attributes is identified. Alternatively, certain attribute types can be more influential in the matching process than other attribute types, such as by using rankings or weightings for attribute types and selecting the attribute set with the highest weighted or ranked degree of match.

In addition, since there can be thousands of predefined mappings for each of many countries of interest, additional information may be used in some embodiments to assist in quickly identifying predefined mappings that are potentially relevant to a particular item. For example, in some embodiments each predefined mapping is associated with one or more countries to which the mapping's tax code or other item classification code corresponds, and is further associated with one or more appropriate categories of items (e.g., based on the item categories used by a merchant selling the items). By associating the mappings with information such as countries and/or item categories, the potentially much smaller number of mappings for a particular target country and item category can be quickly identified. Moreover, in some embodiments subsets of particularly relevant attribute types (e.g., a minimum set of required attribute types) may be defined and used, such that only those attribute sets that match an item's attributes for each of the attribute types in the subset will be selected for more detailed match consideration. Additional details regarding techniques for matching items to attribute sets are discussed in greater detail below.

Moreover, as previously noted, in some embodiments items are automatically classified both with respect to an origination country from which the item is being exported and a destination country into which the item is being imported. While these two classifications may occur independently in some embodiments, in other embodiments an initial classification is used to facilitate additional classifications, such as by first classifying the item to an export tax code of the origination country, and by then using that export tax code of the origination country to assist in the classification of the item to an import tax code of the destination country (e.g., by limiting the number of possible corresponding import tax codes of the destination country, such as based on predefined mappings between such tax codes or instead by using commonalities in the two tax codes, such as when they are both based on a harmonized tax code). In other embodiments, items may be automatically classified with respect to one or more predefined classification systems that are independent of any country and/or of actions such as import/export of the items.

The ability to automatically and dynamically classify items based on item attributes provides a variety of benefits. For example, when new items are added or items are changed, an appropriate classification for the new or changed item can still occur without having to manually designate any information specific to the classification. In addition, since taxes can be dynamically estimated based on a selected tax code, changes in tax rates or tax amounts for a tax code can be easily incorporated without having to manually modify specific tax amounts associated with specific items or groups of items. The calculation or estimation of one or more taxes for an item based on a selected tax code can be performed in a variety of ways in various embodiments, including by using one of various third-party engines that perform such tax calculations.

In addition, by being able to dynamically calculate estimated import and/or export taxes before or during the ordering process for an item in at least some embodiments of the facility, a merchant can calculate the estimated total cost of delivering the item to the recipient (i.e., the total landed cost) if other costs related to the item acquisition and delivery (e.g., shipping, item purchase, etc.) can be determined. Such estimated delivery tax and/or total delivery cost information can also be displayed to a customer before or during the item ordering process, such as to assist the customer in determining whether to purchase an item, and the estimated import and/or export delivery taxes can further be collected on behalf of the customer for forwarding to the appropriate governmental taxing authorities before the items are shipped (e.g., at the time the order is placed), thus reducing the risk to the merchant of uncompensated costs.

In some embodiments, after an item is dynamically classified to one or more import and/or export tax codes and corresponding estimated import and/or export taxes are calculated, additional information is later gathered and tracked about the actual classification that is later manually made for the items during the delivery process, as well as any corresponding import and/or export taxes that are actually charged for the items. This information can be used in a variety of ways. For example, when estimated import and/or export taxes were collected prior to shipment and the actual import and/or export taxes are less than the collected amount, refunds may be provided to the customers. In addition, information about differences between the automatic classifications and the actual manual classifications to import and/or export tax codes can be used to improve the automatic classification process, such as by automatically revising the attribute sets corresponding to the various tax codes to better reflect the actual classification process that occurred, by adjusting weighting weightings or rankings of particular attributes for use with specific items or categories of items, and/or by adjusting attributes that are identified as being in any minimum set for specific items or categories of items.

After items are dynamically classified to appropriate attribute sets and/or corresponding classification codes, that information can also be used in a variety of ways other than estimating delivery taxes. For example, in some embodiments automatically classified import and/or export codes for items may also be used to perform import and/or export compliance with respect to those items, such as by determining that items corresponding to specific import and/or export codes may have additional restrictions. In addition, as new items are being added and corresponding description information for those items is received or specified, an initial automatic classification of the items can be performed to verify that the provided information is correct and that sufficient information about the item has been provided to allow accurate classification. Moreover, in some embodiments additional information related to the import and/or export of the items can be automatically generated, such as electronic and/or hardcopy documentation used for the import and/or export process.

In some embodiments, additional functionality related to importing and/or exporting items may also be provided. For example, when a user in a destination country distinct from a merchant's origination country is ordering an item for delivery, information about the item and about corresponding taxes and other costs may in some embodiments be presented to the user in a language and/or currency corresponding to the destination country, such as in an automatic manner or instead based on user selection of a corresponding option that is automatically provided to the user.

For illustrative purposes, some embodiments of the software facility are discussed below that include particular techniques for describing items and for dynamically classifying items with respect to import and/or export tax codes of particular countries. However, those skilled in the art will appreciate that the invention is not limited to details of these example embodiments, and the techniques described can be used in a wide variety of other situations, including with orders that are placed in ways other than via an electronic marketplace (e.g., telephone orders, in-person orders, etc.) and to classify items into classification systems other than tax codes and for purposes other than estimated tax calculation.

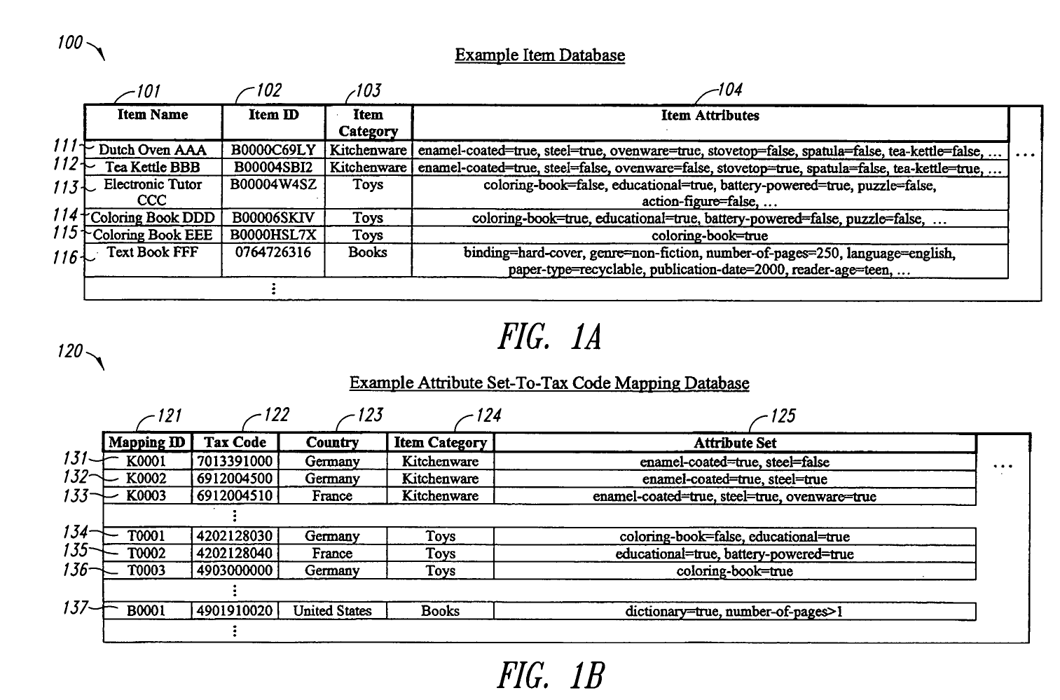

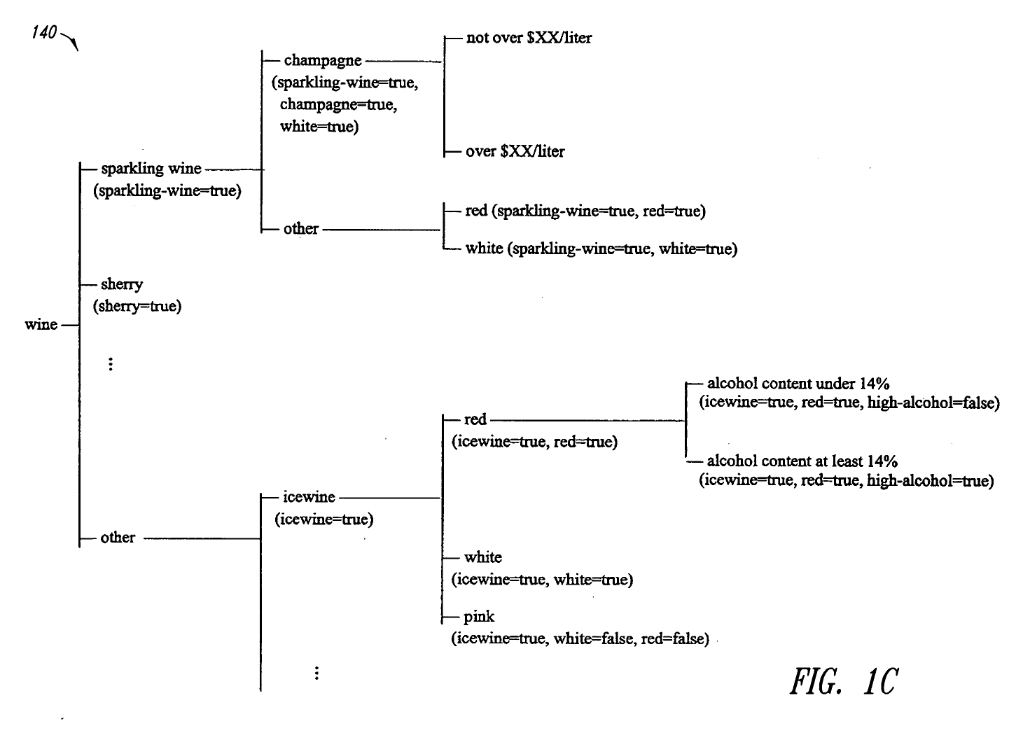

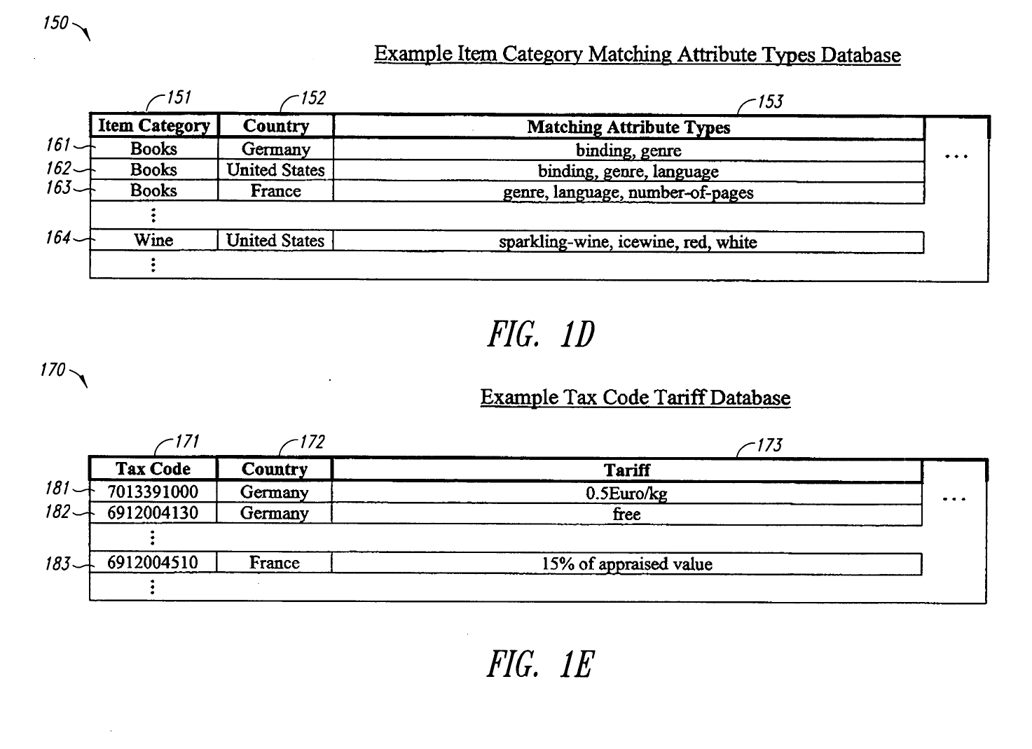

FIGS. 1A-1E illustrate examples of information used for automatically and dynamically classifying items for target countries. In particular, FIG. 1A illustrates an example of an item database 100 that stores various information about items offered by a Web merchant. Each of the entries 111-116 in the database correspond to a distinct item, and the database stores a variety of information about each item. In this example, each item has an item name 101, an item ID 102, an associated category 103 for the item, and various item attributes 104. For example, item 114 is a coloring book that is categorized as a toy, with the item attributes indicating that it is a coloring book and is educational, but is not battery powered or a puzzle. A variety of other types of attributes for toys could instead be specified and used in other embodiments. In addition, some items may have more or less information specified than for other items, such as the coloring book item 115 having only a single attribute specified in this example. Attributes for items could be specified in other ways in other embodiments, including in a non-Boolean manner (e.g., such as the attributes for item 116), by only listing attributes that are true (e.g., by indicating that item 111 includes steel via inclusion of an attribute “steel” and by indicating that item 112 does not steel by the absence of that “steel” attribute), etc. In addition, while item attributes are associated with item categories in this example, in other embodiments item attributes may be independent of category.

FIG. 1B is an example of a database 120 that stores information about predefined mappings of attribute sets to tax codes. Each of the entries 131-137 in the database corresponds to a distinct predefined mapping, with the database storing various information for each of the mappings. In this example, each predefined mapping has a mapping ID 121, a corresponding tax code 122 for a country 123, an associated item category 124, and the set of attributes 125 to which the tax code is mapped. Thus, for example, if item 114 was to be imported into Germany, the item would be classified using the predefined mapping 136 in this example, since all of the attributes in the attribute set for that mapping are satisfied by the item's attributes, and there are not any other illustrated mappings for tax codes of Germany whose attribute sets are a better match. In particular, while mapping 134 also has an attribute in its attribute set that matches item 114's attributes (that being “educational=true”), which gives it the same number of matching attributes as for mapping 136 (i.e., 1), in this example all of the attributes in the attribute set need to match the item attributes in order to select the attribute set as being matching.

Mapping 136 also illustrates that an attribute set does not have to match all of the attributes of an item in this example embodiment, since the item may have some attributes that are useful to a merchant but that are unrelated to the classification process (e.g., the attribute type of “puzzle” for toys such as item 114). However, while the single attribute in the attribute set for mapping 136 provides the best match for item 114 in this example, the mapping might not be selected as the best match for the item if another predefined mapping (not shown) for a tax code of Germany included an attribute set with multiple attributes that all matched attributes of item 114 (e.g., “coloring-book=true” and “educational=true”). In this example embodiment, attribute sets for different predefined mappings for a single country should have distinct attribute sets to allow a best match to be determined, although predefined mappings for different countries can have duplicate attribute sets, but in other embodiments duplicate attribute sets for a single country may be allowed and handled in other ways (e.g., by needing the attribute sets for predefined mappings for a country to be distinct only within certain subsets, such as distinct item categories). Alternatively, different attribute types may be relevant for classification with respect to different countries, such as item 113 matching the predefined mapping 134 based on the item attributes “coloring-book=false” and “educational=true”, and matching the predefined mapping 135 for France based on the item attributes “educational=true” and “battery-powered=true”. Mapping 136 also demonstrates that, while the coloring book item 114 may be categorized as a toy by the Web merchant (as shown in column 124 for mapping 136), for the purposes of Germany's import tax code it is instead classified as a book (as indicated by the corresponding tax code in column 122 for mapping 136 beginning with the harmonized tax code identifier “49” for books and other printed materials).

The use of the illustrated attribute sets allows items to be added or changed and to still be automatically and dynamically classified. For example, if a new toy item is added that is educational and not a coloring book, mapping 134 can be selected when Germany is the target country into which the toy will be imported or from which the toy will be exported. Similarly, if item 114 were altered such that it remains an educational toy but is no longer classified as a coloring book (e.g., by now including colored stickers that children can use to decorate the book's pages), it can similarly be automatically and dynamically re-classified as matching predefined mapping 134.

FIG. 1C illustrates an example of information that can be used with a different technique for matching items to attribute sets, and in particular illustrates a hierarchy 140 of item attributes under the “wine” category that can be used by an example merchant to determine appropriate matching attribute sets. For example, the merchant may desire to classify a red icewine item whose item attributes in the merchant's item description include “icewine=true” and “red=true”. If so, a traversal of the illustrated portion of the hierarchy would begin with the “other” subcategory of wine being selected (assuming that the red icewine did not have item attributes classifying it as being a sparkling wine or sherry), followed by a selection of the “icewine” subcategory, followed by selection of the “red” subcategory. If the item did not have attributes indicating its alcohol content, the classification would stop at that “red” subcategory node in the hierarchy, while if information about the alcohol content was available then one of the further subcategories of that “red” node would be selected as appropriate. While not illustrated here, some or all of the nodes could further have corresponding tax codes associated with them, such that selection of an appropriate matching node would then enable selection of the corresponding associated tax code.

In this example, some attributes are present under different portions of the hierarchy (e.g., the wine colors for “red” and “white”), but the best match is selected based not on matching a highest number of attributes but on the lowest level of the hierarchy whose associated attributes all match attributes of the item. Thus, for example, a sparkling red wine with high alcohol content and a price of a certain specified amount per liter might match more attributes under the high alcohol content subcategory of the “red” icewine node if that node further included a corresponding subcategory (not shown) based on price, since the color, alcohol content and price-related attributes all would be matched. Nonetheless, the best match for the item would be the “red” subcategory under “other” under “sparkling wine”, which includes only two matching attributes (i.e., “red=true” and “sparkling-wine=true”), since in this example the higher-level sparkling wine categorization is more relevant for the classification than the lower level sub-categories related to alcohol content or cost.

While in some embodiments items may be matched to attribute sets of predefined mappings based solely on the types of information illustrated in FIGS. 1B and 1C, in other embodiments additional information can be specified to assist in the matching process. For example, FIG. 1D illustrates an example of a database 150 that includes indications of subsets of attribute types for item categories that are particularly relevant for classification in those categories. Entries 161-164 each correspond to an item category for a country, with columns 151 and 152 indicating the item categories and countries, and with column 153 indicating the subset of relevant attribute types. Thus, in a manner somewhat analogous to the hierarchy in FIG. 1C, entry 164 indicates that for the United States in the wine category the most relevant attribute types to match for classification purposes are those for the wine types “sparkling-wine” and “icewine” and for the wine colors “red” and “white.” Similarly, entry 161 indicates that in Germany the types of attributes of books that are most relevant for classification include their binding and genre. Thus, when mapping a book item to an appropriate attribute set for a German tax code, the matching process may eliminate any attribute sets in which the binding or genre of the attribute set do not match the binding and genre of the item being matched. In this manner, the most relevant group of attribute sets for predefined mappings can be quickly identified, and a best match among those remaining attribute sets can then be selected (e.g., based on the other matching techniques previously discussed). In other embodiments, additional information could be specified, such as a weighting or ranking to be given to each attribute to be used in calculating a weighted match.

FIG. 1E illustrates an example of a database 170 to be used for calculating an estimated tax for import into or export from a target country based on a tax code classification for an item. In particular, each of the entries 181-183 correspond to a tax code for a country, as shown in columns 171 and 172, and column 173 indicates a corresponding tax amount or rate for items classified to that tax code. Using the information in column 173, possibly with additional information about an item (e.g., a weight of an item when the tax amount varies based on weight), an estimated import tax for importing the item into the target country in column 172 or an estimated export tax for exporting the item from the target country in column 172 can be calculated. In other embodiments, a variety of additional information could be used in estimating a tax if the tax varies based on other factors, such as a current or total number of items in an order that correspond to the tax code, other types of items included together in a single order, etc. As discussed elsewhere, the calculation or estimation of such taxes can be performed in a variety of ways, including by using various third-party calculation engines.

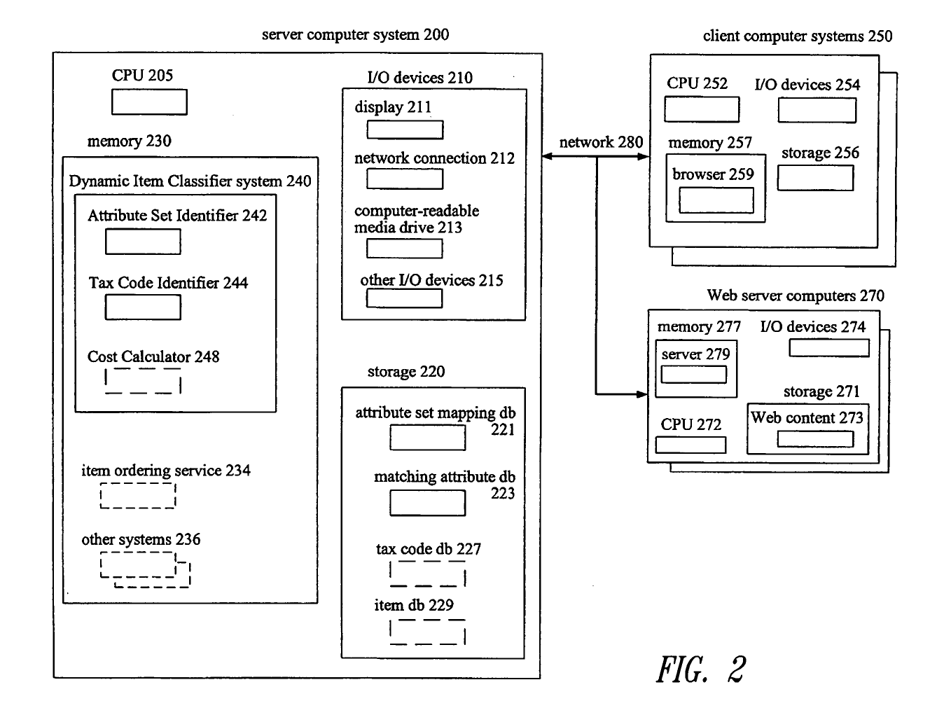

FIG. 2 illustrates a server computing system 200 suitable for executing an embodiment of a Dynamic Item Classifier system facility 240 for dynamically classifying items, as well as other computer systems 250 and 270 with which the server computing system 200 can interact via network 280. The server computing system includes a CPU 205, various I/O devices 210, storage 220, and memory 230. The I/O devices include a display 211, a network 212, a computer-readable media drive 213, and other I/O devices 215.

An embodiment of the Dynamic Item Classifier system 240 is executing in memory 230, and it includes an Attribute Set Identifier component 242, a Tax Code Identifier component 244, and optionally a Cost Calculator component 248. The system 240 receives indications of items to be classified with respect to a target country, and automatically identifies an appropriate tax code classification for the item for that country. In some embodiments, the system 240 may further estimate a tax cost corresponding to importing the item into that target country and/or exporting that item from that target country.

When the system receives an indication of an item to be classified for a target country, the information is provided to the Attribute Set Identifier component 242. The component 242 retrieves information from database 221 on storage 220 regarding predefined mappings of attribute sets to corresponding tax codes for the target country. In the illustrated embodiment, the component 242 also has access to a matching attribute database 223 on storage that includes additional information about how to perform the matching of the item to a particular attribute set, such as a ranking of or subset of attribute types for the matching. The component 242 then selects the best matching attribute set from the predefined mappings and provides the information to the Tax Code Identifier component 244. The component 244 then identifies an appropriate tax code corresponding to the attribute set, such as a tax code associated with the predefined mapping containing the selected attribute set. In embodiments in which the system 240 further includes the Cost Calculator component 248, that component then receives information about the identified tax code and obtains information about corresponding tax amounts or rates from a tax code database 227 on storage. The component 248 then uses the obtained tax amount or rate information as well as information about the item to estimate a tax amount corresponding to the item and the target country.

In some embodiments, the system 240 operates independently of any particular merchant or other item ordering service, such as by providing its item classification capabilities to multiple users—if so, the system 240 will typically receive sufficient information about the items from those other systems to perform the selection of the appropriate attribute set (e.g., attributes and categories of the items to be classified). In other embodiments, the system 240 may instead operate in conjunction with one or more specific item ordering services, such as an optional item ordering service 234 executing in memory 230. That item ordering service may make items available to customers for purchase, such as users of client computer systems 250, and may further store various information about the available items in an item database 229 on storage. The system 240 may further in some embodiments interact with one or more other systems 236 executing in memory, such as to perform additional functionality such as import/export compliance for items based on dynamic classification of the items, language and/or currency conversion based on origination and/or destination countries that are different from the a country of the merchant, etc.

When the optional item ordering service 234 is present, it may also operate in conjunction with one or more Web server computers 270, such as to provide information about the items to users of the client computers 250. Alternatively, the system 240 may instead directly interact with one or more remote computing systems to provide its capabilities, such as one or more of the Web server computers 270 (e.g., computers in use by Web merchants). Such Web servers may provide various Web content 273 to customers or other users of client computer systems via browsers 259 executing in memory 257 of those client computer systems, such as via a Web server 279 executing in memory 277 of the Web server computer.

Those skilled in the art will appreciate that computing systems 200, 250 and 270 are merely illustrative and are not intended to limit the scope of the present invention. Computing system 200 may be connected to other devices that are not illustrated, including through one or more networks such as the Internet or via the World Wide Web (“Web”). More generally, a “client” or “server” system or device may comprise any combination of hardware or software that can interact and provide the indicated functionality, including computers, network devices, internet appliances, PDAs, wireless phones, cellphones, pagers, electronic organizers, television-based systems and various other consumer products that include inter-communication capabilities. In addition, the functionality provided by the illustrated system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

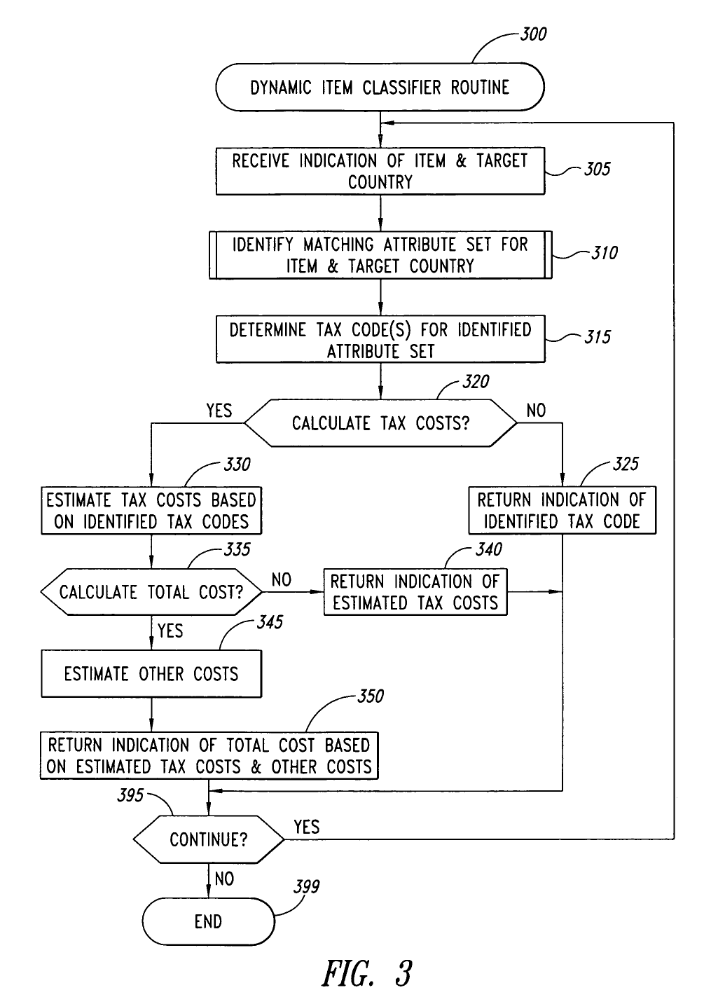

FIG. 3 is a flow diagram of an embodiment of a Dynamic Item Classifier routine 300. The routine receives indications of items and classifies those items to reflect an appropriate tax code for an indicated target country (e.g., a destination country into which the item is being imported). In some embodiments, the routine further estimates the amount of one or more taxes for the target country based on the identified tax code, such as to enable a determination of a total landed cost for delivering the item to a recipient in a destination country. While not illustrated here, in some embodiments the routine could further be integrated with or otherwise support one or more Web merchants or other item ordering services, such as to allow information about the estimated taxes to be provided to a customer of an item ordering service (e.g., before or during the ordering process for the item).

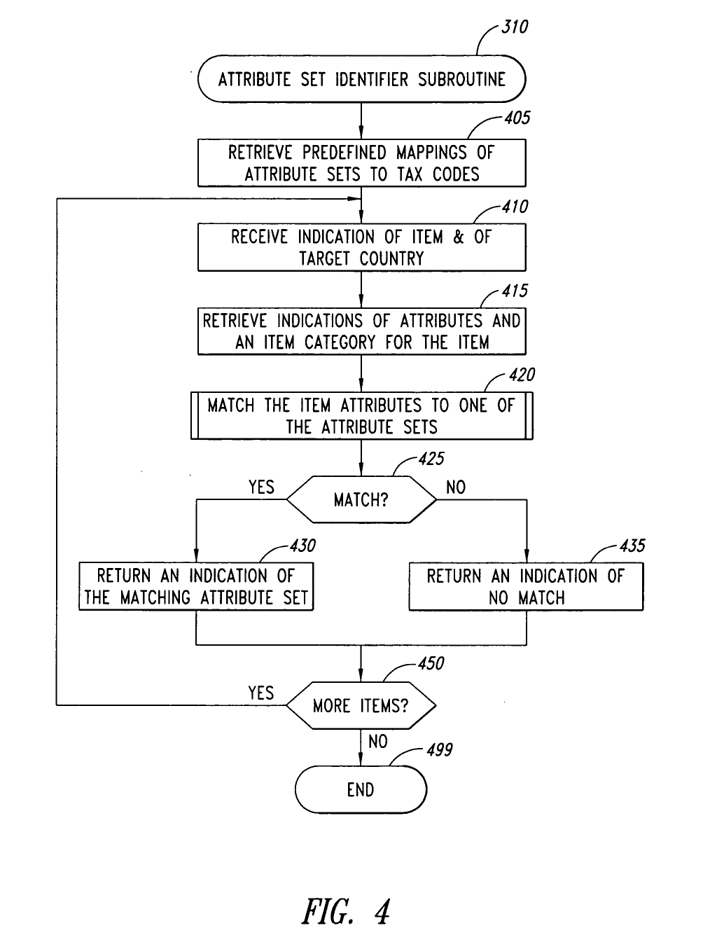

The routine begins at step 305, where an indication is received of an item and of a target country for which item classification is desired. The routine continues to execute subroutine 310 to identify a predefined attribute set for the target country that best matches the item, as discussed in greater detail with respect to FIG. 4. In step 315, the routine then identifies one or more tax codes for the target country that correspond to the identified attribute set. The tax code(s) could be identified in various ways, such as based on a predefined mapping of the identified attribute set to one or more of the tax codes.

After step 315, the routine continues in this embodiment at step 320 to determine whether to calculate tax costs for the one or more identified tax codes, although in other embodiments such tax calculation may not be performed. If not, the routine continues to step 325 to return an indication of the identified tax code(s). If it was instead determined in step 320 to calculate tax costs, the routine continues instead to step 330 to estimate the tax cost for the item in the target country based on the identified tax codes. For example, in some situations the target country may be a destination country into which the item is being imported, and if so the tax codes and corresponding tax costs may reflect import duty tariffs and other import taxes. Similarly, in some situations and embodiments the target country may be an origination country from which the item is being exported, with the identified tax codes and corresponding estimated tax costs corresponding to various types of export costs. The determining of the tax cost based on an identified tax code can be performed in various ways, such as based on a tax schedule provided by the target country that specifies a particular tax amount or tax rate for the tax code. In some embodiments, the calculation or estimation of such taxes can be performed by using various third-party calculation engines.

After step 330, the routine continues to step 335 to determine whether to further calculate a total cost with respect to the item and target country, such as when the target country is a destination country into which the item is being imported, with the total cost indicating the full total of delivering the item to a recipient in that destination country. If not, the routine continues to step 340 to return an indication of the tax cost determined in step 330, optionally along with an indication of the identified tax code(s). If it is instead determined in step 335 to calculate the total cost, the routine continues to step 345 to calculate other estimated costs associated with sending an item to or from the target country, such as shipping costs, insurance costs, costs of acquiring the item, etc. In some situations in which the target country is a destination country into which the item is being imported, the calculation of other estimated costs can further include calculation of an export-related cost for the item, such as by executing the routine 300 with an origination country for the item shipment identified as the target country. After step 345, the routine continues to step 350 to return an indication of the estimated total cost based on the estimated tax cost from step 330 and the other estimated costs from step 345. After steps 325, 340, or 350, the routine continues to step 395 to determine whether to continue. If so, the routine returns to step 305, and if not the routine continues to step 399 and ends.

While not illustrated here, in other embodiments this or a related routine could provide further functionality related to item classification. For example, in some embodiments one or more of the identified tax codes, the estimated tax cost from step 330, and the calculated total cost could be displayed to a user, such as a customer for the item (whether before, during or after an ordering process for the item is performed). In addition, the identified attribute set and/or tax code for an item can further be used for purposes other than estimating of taxes, such as to perform import and/or export compliance for an item with respect to the target country. In addition, while in the illustrated embodiment the routine can be used for either import or export cost, in other embodiments the routine may support only one such functionality. Alternatively, in embodiments in which the routine can perform both types of functionality, additional information could be provided with respect to step 305, such as an indication of whether the target country is an origination or a destination country. Furthermore, in some embodiments the identification of an appropriate tax code for the destination country could be performed in multiple stages, such as by first identifying an attribute set and corresponding tax code for the origination country and then using that origination country tax code to assist in identifying an appropriate corresponding tax code of a destination country.

FIG. 4 is a flow diagram of an embodiment of an Attribute Set Identifier subroutine 310. The subroutine receives an indication of an item and determines an appropriate matching predefined attribute set if possible.

The subroutine begins in step 405, where indications are retrieved of multiple predefined mappings of attribute sets to corresponding tax codes of specified countries. In the illustrated embodiment, each of the predefined mappings are further associated with a category of items, although in other embodiments the mappings may be independent of any such item categories. The predefined mappings could be created before being retrieved in a variety of ways, such as based on manual mappings of attribute sets to tax codes (e.g., based on sets of attributes for items that were previously associated with tax codes of a specified country by officials of that country during an import and/or export process for that country, or instead based on attempts to identify appropriate attribute sets for such tax codes in advance of the actual import and/or export process) or instead based on using various automated techniques (e.g., automated learning of appropriate attribute sets for tax codes based on the previous manual classifications done by officials of the appropriate import and/or export countries).

After step 405 is initially performed, the subroutine continues to steps 410-450 to identify attribute sets for one or more items based on the predefined mappings, although in other embodiments step 405 could be performed after a particular item and target country are identified (e.g., to retrieve only predefined mappings for that country and for the one or more item categories to which the item belongs). In particular, in step 410 an indication is received of an item and of a target country, such as a destination country into which the item is to be imported. In step 415, information about the item is then retrieved for use in the matching process, including attributes of the item and in the illustrated embodiment an item category for the item. In other embodiments, other types of information about items could be received and used (e.g., ranking or weighting of some or all attributes that the item may have, indications of other items that are part of a single order with the current item, a number of copies of the indicated item in a current order and/or in past orders, etc.), and any such information could instead be supplied in step 410 rather than being retrieved in step 415 (e.g., by receiving an indication of item attributes and an item category in step 410, whether instead of or in addition to an indication of the item).

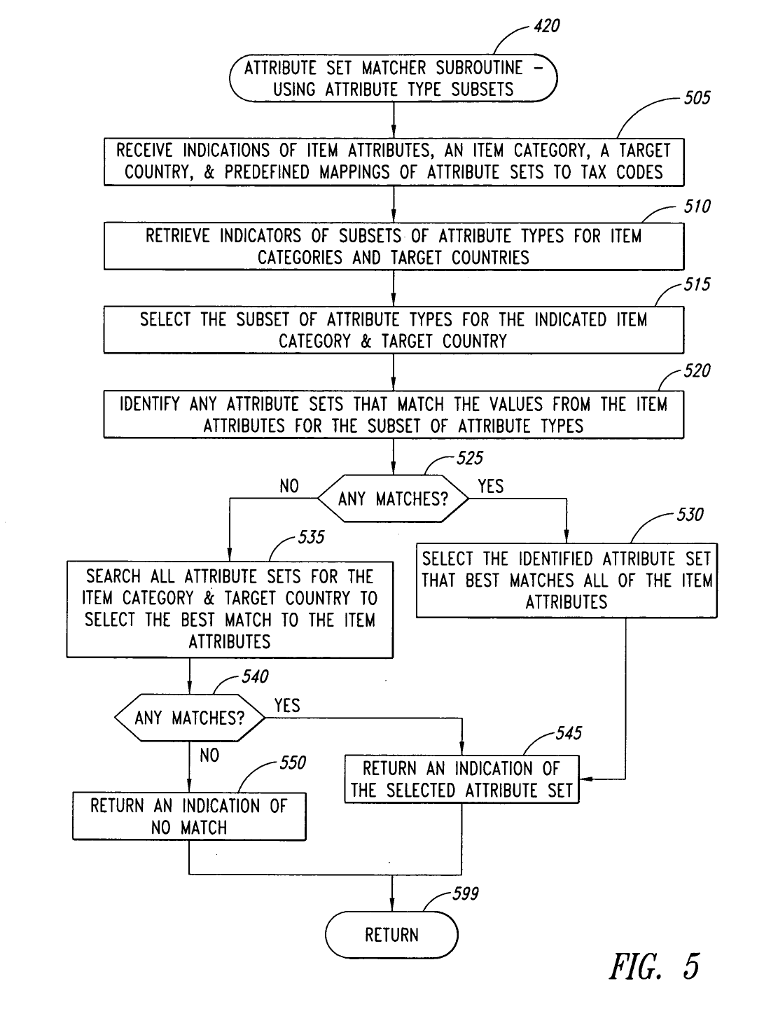

After step 415, the subroutine continues to execute subroutine 420 to attempt to match the attributes of the item to the attribute set for one of the predefined mappings, with one example of such a subroutine described in greater detail with respect to FIG. 5. If it is then determined in step 425 that a match was found, the subroutine continues to step 430 to return an indication of the attribute set that was identified, and otherwise continues to step 435 to return an indication that no match was found. The indication of the attribute set can have various forms, such as a unique ID associated with the predefined mapping. After steps 430 or 435, the subroutine continues to step 450 to determine whether there are more items for which attribute sets are to be identified (e.g., other items from a single order being delivered to a recipient in a destination country). If so, the subroutine returns to step 410, and if not continues to step 499 and ends.

FIG. 5 is a flow diagram of an embodiment of an Attribute Set Matcher subroutine 420. As previously noted, the matching of an item to a predefined attribute set can be performed a variety of ways in various embodiments. In this example embodiment, the matching is performed based on using a subset of attribute types for an item category to initially identify the most relevant predefined attribute sets, and to then select the one such attribute set that matches the most attributes of the item when possible. In alternative embodiments, identification of an appropriate attribute set for an item can be performed in other manners, whether instead of or in addition to using predefined matching attribute types, such as based on a hierarchy of item types and/or attribute types, by identifying an attribute set that matches all attributes of an item, etc.

The subroutine begins at step 505, where an indication is received of item attributes and an item category for an item, a target country, and predefined mappings of attribute sets to tax codes (although in other embodiments the predefined mappings could instead be retrieved by the subroutine as needed). In step 510, the subroutine then retrieves indications of subsets of attribute types for item category and target country combinations, which will be used for initial matching for items of those categories in those target countries. After step 510, the subroutine continues to step 515 to select one of the subsets of attribute types based on the item category and the target country received in step 505.

In step 520, the subroutine next identifies values from the item's attributes for the types of attributes in the selected subset, and then identifies attribute sets for the item category and target country that have attributes of those types with those values. The subroutine then continues to step 525 to determine whether there were any matches, and if so continues to step 530 to select the identified attribute set from step 520 that best matches the item, such as by matching the largest number of the item's attributes. If it was instead determined in step 525 that there were no matches, the subroutine continues instead to step 535 to search all of the attribute sets for the item category and the target country to select a best match, such as the attribute set that matches a largest number of the attributes (or a largest number of the attributes for the attribute types in the selected subset). While not illustrated here, in some embodiments a threshold may further be defined in order to determine whether a degree of match in step 535 is sufficiently high for any of the attribute sets being searched, while in other embodiments a determination will instead be made that there is no matching attribute set if no matches are found in step 520. In the illustrated embodiment, after step 535 the subroutine continues to step 540 to determine whether any additional match was identified, and if not continues to step 550 to return an indication that no match was found. If it was instead determined in step 540 that a match was found, or instead after step 530, the subroutine continues to step 545 to return an indication of the selected attribute set. After steps 545 or 550, the subroutine continues to step 599 and returns.

Those skilled in the art will also appreciate that in some embodiments the functionality provided by the routines and subroutines discussed above may be provided in alternative ways, such as being split among more routines or consolidated into less routines. Similarly, in some embodiments illustrated routines and subroutines may provide more or less functionality than is described, such as when other illustrated routines or subroutines instead lack or include such functionality respectively, or when the amount of functionality that is provided is altered. In addition, while various operations may be illustrated as being performed in a particular manner (e.g., in serial or in parallel, or synchronously or asynchronously) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A method for a computing system of a Web merchant to assist customers in placing product orders to be delivered internationally by automatically classifying the products, the Web merchant selling multiple types of products in a first country, each of the products associated with a product category and having an associated description that includes multiple attributes, the method comprising:
retrieving multiple defined mappings that each associate a set of multiple product attributes for a specified product category with a harmonized tax code of a specified destination country, the harmonized tax code for use by the destination country in charging taxes on imported products; and
for each of multiple potential orders that are each indicated by a customer to include one or more products and to have a recipient in a second country distinct from the first country,
before receiving an indication from the customer to place the potential order, automatically determining costs for delivering the potential order to the recipient in the second country by,
for each of the included products,
dynamically classifying the product as belonging to a product group associated with a harmonized tax code of the second country, the dynamic classifying including determining one of the defined mappings that best matches the product based at least in part on a match between the attributes of the product and the set of product attributes for that mapping and on the specified destination country and product category of that mapping being the second country and the product category associated with the product; and
estimating tax that will be charged by the second country for importing the product into the second country, the estimating based at least in part on the dynamic classifying such that the harmonized tax code for the determined mapping is used for calculating the estimated tax;
determining other costs associated with delivering the potential order to the recipient in the second country; and
determining a total cost to the customer for the potential order that includes having the order delivered to the recipient in the second country, the determined total cost based at least in part on the estimated taxes for the included products, on the determined other costs associated with order delivery, and on a cost charged by the Web merchant for the included products; and
after displaying to the customer the determined total cost, receiving an indication from the customer to place the potential order and obtaining from the customer the determined total cost before delivering the order to the recipient, so that a total cost of an order being delivered internationally can be dynamically determined and used when the order is being placed based on a dynamic determination of import taxes using attributes of products in the order.

2. The method of claim 1 wherein each of the determined other costs associated with delivering of a potential order to a recipient in a second country includes a cost of shipping the order to the second country and any costs that will be charged by the first country for exporting the products included in the order.

3. The method of claim 1 wherein each of the estimated taxes charged by a second country for importing a product into the second country includes an import duty tariff of the second country for the product and any non-duty taxes that will be charged by the second country for the product.

4. The method of claim 1 wherein the Web merchant makes a new product available for sale that has an associated description with multiple attributes, and including, without having any manually specified information about any harmonized tax codes or import taxes for the new product, estimating a tax that will be charged by a second country for importing the new product into the second country when the new product is included in a potential order with a recipient in the second country, the estimating based at least in part on a harmonized tax code for one of the defined mappings that is dynamically determined to be a best match for the new product based at least in part on the attributes of the new product and the set of product attributes for that mapping.

5. The method of claim 1 wherein one of the products being sold by the Web merchant is changed in such a manner that the attributes in the associated description for that product are changed, and including, without having any manually specified information about any harmonized tax codes or import taxes for the changed product, estimating a tax that will be charged by a second country for importing the changed product into the second country when the changed product is included in a potential order with a recipient in the second country, the estimating based at least in part on a harmonized tax code for one of the defined mappings that is dynamically determined to be a best match for the changed product based at least in part on the changed attributes of the changed product and the set of product attributes for that mapping, the dynamic determining such that the dynamically determined mapping for the changed product with the changed attributes is different from a previous dynamically determined mapping for the product before the change.

6. The method of claim 1 wherein each of the harmonized tax codes of a destination country has an associated tariff amount that is used by the destination country in charging taxes on imported products, wherein one of the destination countries changes the associated tariff amount for one of the harmonized tax codes of that destination country, and including, without modifying any defined mappings for that one harmonized tax code for that destination country, estimating a new tax that will be charged by the destination country for importing a product when the product is included in a potential order with a recipient in the destination country, the estimating based at least in part on that one harmonized tax code and the changed associated tariff amount such that the estimated new tax for the product is different from a previous estimated tax for importing the product into the destination country before the change.

7. The method of claim 1 including, after displaying to a customer the determined total cost for having a potential order delivered to a recipient in a second country, receiving an indication from the customer of a different recipient in a different country for the potential order, and in response automatically determining a different total cost for delivering the potential order to the different recipient in the different country by,
for each of the products included in the potential order,
dynamically determining a different one of the defined mappings that is a best match for the product and such that the specified destination country of the determined different mapping is the different country; and
estimating a different tax that will be charged by the different country for importing the product into the different country, the estimating based at least in part on the harmonized tax code for the different determined mapping;
determining other costs associated with delivering the potential order to the different recipient in the different country; and
determining the different total cost to the customer for the potential order that includes having the order delivered to the different recipient in the different country, the determined total cost based at least in part on the different estimated taxes for the included products, on the determined other costs associated with order delivery to the different country, and on the cost charged by the Web merchant for the included products.

8. The method of claim 1 wherein at least some of the product attributes are hierarchically organized such that a highest level of the hierarchy is a most general category of products and such that successive levels of the hierarchy each reflect sub-categories of the category of products for the next higher level of the hierarchy, and wherein the dynamic determining of a defined mapping that is a best match for a product includes, for a group of defined mappings having sets of product attributes such that each of the attributes in each of the sets matches one of the attributes of the product, selecting the defined mapping from the group whose set of attributes includes attributes at a lowest level of the hierarchy.

9. The method of claim 1 including, after each dynamic determining of a defined mapping that is a best match for a product included in a potential order having a recipient in a second country, determining based at least in part on the harmonized tax code for the determined mapping whether the product is allowed to be imported into the second country from the first country and/or to be exported from the first country to the second country.

10. A computer-implemented method to assist international delivery of items from an origination country by automatically classifying items, the method comprising:
receiving indications of multiple defined mappings that each associate a set of multiple item attributes with a tax code of a destination country; and
for each of multiple orders that each include one or more items and have an associated destination country for order delivery, and before delivering the order,
automatically determining delivery tax costs for the order by, for each of at least some of the included items,
dynamically selecting one of the defined mappings for the item based at least in part on a degree of match between attributes of the item and the set of item attributes for that mapping; and
estimating a delivery tax for delivery of the item to the destination country associated with the order that will be charged by that destination country, the estimated tax based at least in part on the tax code for the selected mapping; and
determining an amount to charge for the order based in part on the estimated delivery taxes for the included items.

11. The method of claim 10 including, before delivering each of the orders, obtaining payment from a customer for the determined amount for the order.

12. The method of claim 10 including, for each of the orders and before placing of the order by a customer is completed, providing an indication to the customer of one or more costs for the order that include the determined amount for the order.

13. The method of claim 12 wherein the determined amount for each of the orders is a total cost to the customer of having the order delivered to the associated destination country for the order.

14. The method of claim 12 wherein the determined amount for each of the orders includes shipping costs associated with delivering the order to the associated destination country for the order and a cost for purchasing the items included in the order.

15. The method of claim 12 including, before delivering each of the orders, obtaining payment from the customer for the indicated costs for the order.

16. The method of claim 10 wherein the automatic determining of the delivery tax costs for an order is performed dynamically when the order is placed.

17. The method of claim 10 including receiving an indication that a new item is available and automatically estimating a delivery tax for delivery of the new item to a destination country based at least in part on a tax code for one of the defined mappings that is dynamically selected for the new item, the selection based at least in part on a degree of match between attributes of the new item and the set of item attributes for that mapping.

18. The method of claim 17 wherein the automatic estimating of the delivery tax for the delivery of the new item to the destination country is performed without any manually specified information about any tax codes for the new item.

19. The method of claim 10 including receiving an indication that the attributes of one of the items have changed and automatically estimating a different delivery tax for delivery of that item to a destination country based at least in part on a tax code for a different one of the defined mappings that is dynamically selected for that item, the selection based at least in part on a degree of match between the changed attributes of that item and the set of item attributes for that one mapping and such that the one mapping dynamically selected based at least in part on the changed attributes is different from a previous dynamically selected mapping for the item before the change.

20. The method of claim 19 wherein the automatic estimating of the delivery tax for the delivery of the item with the changed attributes to the destination country is performed without any manually specified information about any tax codes for the item.

21. The method of claim 10 wherein each of the tax codes of a destination country has an associated tariff amount that is used by the destination country in charging taxes on items, wherein one of the destination countries changes the associated tariff amount for one of the tax codes of that destination country, and including automatically estimating a new delivery tax for delivery of an item to the destination country based at least in part on that one tax code and the changed associated tariff amount such that the estimated new delivery tax for the item is different from a previous estimated delivery tax for the item before the change.

22. The method of claim 21 wherein the automatic estimating of the new delivery tax for the item is performed without any manual changes to any defined mappings for the one tax code with the changed associated tariff amount.

23. The method of claim 10 including, after determining an amount to charge for an order based in part on the estimated delivery taxes that will be charged by a destination country for the items included in the order, receiving an indication of a different destination country for the order and automatically determining a different amount to charge for the order based in part on different estimated delivery taxes that will be charged by the different destination country.

24. The method of claim 23 wherein the different estimated delivery taxes for the order are each based in part on a different tax code from a different one of the defined mappings that is dynamically selected for an item included in the order.

25. The method of claim 10 wherein the determined amount to charge for each of the orders is further based in part on one or more additional estimated taxes that will be charged by an origination country from which the order will be delivered, each of the additional estimated taxes determined based at least in part on a tax code for the origination country that is associated with an additional selected defined mapping, that additional defined mapping selected from multiple additional defined mappings for the origination country based at least in part on a degree of match between a set of item attributes for that mapping and attributes of one or more of the items of the order.

26. The method of claim 10 including, after each dynamic selecting of a defined mapping for an item included in an order with an associated destination country, determining based at least in part on the tax code for the determined mapping whether the item is allowed to be imported into the destination country from an origination country.

27. The method of claim 10 including, for each of at least some of the items included in an order with an associated destination country, determining based at least in part on an export code dynamically selected for the item whether the item is allowed to be exported from an origination country to the destination country, the dynamic selecting of the export code including dynamically selecting one of multiple additional defined mappings that each associate a set of multiple item attributes with an export code of the origination country such that the dynamically selected export code is the export code of the dynamically selected additional defined mapping.

28. The method of claim 10 including, after delivering an order of a customer to a destination country, obtaining for each of at least some of the items included in the order an indication of an actual delivery tax charged by the destination country for that item, and when the actual delivery tax charged for an item of the order is less than the estimated delivery tax for that item, automatically lowering the determined amount to charge the customer for the order.

29. The method of claim 10 including, after delivering an order of a customer to a destination country, obtaining for each of at least some of the items included in the order an indication of an actual tax code used by the destination country for that item, and when the actual tax code for an item differs from the tax code from the selected mapping for the item that was used to estimate the delivery tax for the item, automatically generating a defined mapping for the actual tax code with a set of multiple item attributes that include at least some of the attributes of the item.

30. The method of claim 10 including receiving an indication of one or more attributes for a new item that is available and automatically determining whether to obtain additional attributes for use in dynamically selecting one of the defined mappings for the new item, the automatic determining based at least in part on the sets of attributes for the defined mappings.

31. The method of claim 10 wherein a customer for an order is associated with a customer country distinct from the origination country, and including automatically providing information to the customer in a language associated with the customer country that is distinct from a default language used in the origination country.

32. The method of claim 10 wherein a customer for an order is associated with a customer country distinct from the origination country, and including automatically providing information about costs to the customer in a currency associated with the customer country that is distinct from a default currency used in the origination country.

33. The method of claim 10 wherein the method is performed by a computing system of a merchant located in the origination country.

34. The method of claim 10 wherein the orders are each shipped from the origination country to the distinct destination country for the order.

35. The method of claim 10 wherein the orders are each placed by a customer in the origination country.

36. The method of claim 10 wherein the dynamic selecting of a defined mapping for an item in an order includes selecting the defined mapping whose set of attributes matches a largest number of the attributes of the item.

37. The method of claim 10 wherein the dynamic selecting of a defined mapping for an item in an order includes selecting a defined mapping whose set of attributes matches all of the attributes of the item.

38. The method of claim 10 wherein at least some of the item attributes are organized in a hierarchy such that each node of the hierarchy corresponds to a subset of items that correspond to a parent node at a next higher level of the hierarchy, and wherein the dynamic selecting of a defined mapping for an item in an order includes selecting one of a group of defined mappings having sets of item attributes such that each of the attributes in each of the sets matches one of the attributes of the item, the selected one of the group being the defined mapping whose set of attributes includes attributes at a lowest level of the hierarchy.

39. The method of claim 10 wherein each of the items is associated with at least one item category, wherein each of the item categories has an associated set of one or more minimum matching attributes, and wherein the dynamic selecting of a defined mapping for an item in an order includes selecting one of a group of defined mappings whose sets of item attributes each include all of the minimum matching attributes for at least one of the item categories of the item.

40. The method of claim 10 wherein, for each of at least some of the orders, the destination country for the tax code of the selected defined mapping is distinct from the associated destination country for the order, and wherein the estimating of the delivery tax for delivery of the item to the destination country associated with the order includes selecting a distinct tax code of the associated destination country for the order based in part on the tax code of the selected defined mapping and using the selected distinct tax code of the associated destination country for calculating of the estimated delivery tax.

41. The method of claim 10 wherein the dynamic selecting of a defined mapping for an item in an order with an associated destination country is further performed so as to select one of the defined mappings whose tax code is for the associated destination country.

42. The method of claim 41 wherein each of the defined mappings further has an associated category of items, and wherein the dynamic selecting of a defined mapping for an item in an order with an associated destination country is further performed so as to select one of the defined mappings whose associated category of items matches an item category of the item.

43. The method of claim 10 wherein each of the orders is a potential order that has not yet been placed by a customer.

44. The method of claim 10 wherein each of the tax codes of a destination country is a harmonized tax code of that country.

45. A computer-readable medium whose contents cause a computing device to assist in automatically classifying items, by performing a method comprising:
for each of multiple items,
automatically selecting a predefined classification indication to which the item corresponds, the selected classification indication being part of a predefined classification system having multiple classification indications, the selecting of the classification indication to which the item corresponds based at least in part on information related to the selected classification indication that is associated with one of multiple predefined sets of item attributes that is selected as matching attributes of the item; and
providing an indication of the selected classification indication for use in processing related to the item.

46. The computer-readable medium of claim 45 wherein the multiple items are each being sent to a destination, and wherein the automatic selecting of the predefined classification indication for each of the items is performed dynamically at a time proximate to the sending of the item to the destination and/or to receipt of an instruction to send the item to the destination.

47. The computer-readable medium of claim 46 wherein each of the destinations is an international destination, wherein the predefined classification system for each of the items is a tax code system related to the international destination to which the item is being sent such that the selected classification indication for an item is a tax code to which the item is classified, wherein the automatic selecting of the predefined classification indication for each of the items further includes estimating one or more tariffs for sending that item to its destination based at least in part on the tax code to which the item is classified, and wherein the providing of the indication of the selected classification indication for an item includes providing an indication of the estimated tariffs for that item for use in determining a cost for sending the item to the destination.

48. The computer-readable medium of claim 47 wherein, for each of the items, the information related to the selected classification indication that is associated with the selected item attribute set for that item is a tax code of the destination for that item.

49. The computer-readable medium of claim 47 wherein the providing of the indication of the estimated tariffs for each of the items includes providing an indication of a total cost for sending the item internationally to its destination that is based in part on the estimated tariffs for the item, the indication of the determined total cost for the item provided to a user for approval before performing the sending of the item to its destination.

50. The computer-readable medium of claim 45 wherein the multiple items are each being sent internationally to a destination country, and wherein the predefined classification system for each of the items is an import tax code system related to the destination country to which the item is being sent.

51. The computer-readable medium of claim 45 wherein the multiple items are each being sent internationally from an origination country, and wherein the predefined classification system for each of the items is an export tax code system related to the origination country from which the item is being sent.

52. The computer-readable medium of claim 45 wherein the multiple items are each being sent internationally to a destination country, and wherein the predefined classification system for each of the items is an import compliance classification system related to the destination country to which the item is being sent.

53. The computer-readable medium of claim 45 wherein the multiple items are each being sent internationally from an origination country, and wherein the predefined classification system for each of the items is an export compliance classification system related to the origination country from which the item is being sent.

54. The computer-readable medium of claim 45 wherein the computer-readable medium is a memory of a computing device.

55. The computer-readable medium of claim 45 wherein the computer-readable medium is a data transmission medium transmitting a generated data signal containing the contents.

56. The computer-readable medium of claim 45 wherein the contents are instructions that when executed cause the computing device to perform the method.

57. The computer-readable medium of claim 45 wherein the contents include one or more data structures for use in performing the automatic selecting of a predefined classification indication to which an item corresponds, the data structure comprising multiple entries that each correspond to a predefined mapping of a set of item attributes to a corresponding classification code of a specified country, so that the classification code of one of the predefined mappings can be used for the determining how to process the item with respect to the specified country after attributes of the item are matched to the set of item attributes for that mapping.

58. A computing device configured to assist international delivery of items from an origination country, comprising:
a delivery tax estimator component configured to, for each of multiple items that are each to be delivered internationally to a destination country, estimating delivery tax costs for the item based on a tax code automatically selected for the item, the selecting of the tax code including selecting one of multiple defined mappings that each associate a set of multiple item attributes with a tax code of the destination country, the selecting of the one defined mapping based at least in part on a degree of match between attributes of the item and the set of item attributes for that mapping, the automatically selected tax code being the tax code associated with the selected defined mapping; and
an item delivery component configured to, before delivering an item internationally to a destination country, providing to a user an indication of the estimated delivery tax costs for the item.

59. The computing device of claim 58 wherein the indication provided to a user of the estimated delivery tax costs for delivering an item to a destination country includes an indication of a total amount to charge the user for the delivering of the item, and wherein the item delivery module is further configured to provide the indication of the total amount to the user before the user has completed a process of requesting to have the item delivered to the destination country and is further configured to obtain compensation for the total amount from the user before the delivering of the item is performed.

60. The computing device of claim 58 wherein the delivery tax estimator component and the item delivery component are executing in memory of the computing device.

61. The computing device of claim 58 wherein the delivery tax estimator component consists of a means for estimating delivery tax costs for each of the multiple items based on the tax code automatically selected for the item using the selected defined mapping for the item, and wherein the item delivery component consists of a means for providing to a user an indication of the estimated delivery tax costs for an item before delivering the item internationally to a destination country.
